(19) United States
(12) Patent Application Publication
(10) Pub. No.: US 2026/0203681 A1
(43) Pub. Date: Jul. 16, 2026

(54) DYNAMIC SKILLS-BASED REGISTRATION AND ROUTING IN A FRAMEWORK OF ARTIFICIAL INTELLIGENCE AGENTS

(71) Applicant: Cisco Technology, Inc., San Jose, CA (US)

(72) Inventors: Samer M. Salam, Beirut (LB); Arjun Sambamoorthy, San Jose, CA (US); Eric A. Voit, Bethesda, MD (US)

(21) Appl. No.: 19/025,137

(22) Filed: Jan. 16, 2025

(51) Int. Cl. G06Q 10/0631

(52) U.S. Cl. CPC G06Q 10/063112

(57) ABSTRACT

An example embodiment provides for skill-based registration and routing across artificial intelligence (AI) agents in a fabric or framework based on semantic overlap in a vector space using polytope boundaries for skill advertisement and route look-up. A method involves defining, via at least one processor, regions for corresponding agents of a framework within a multidimensional space, wherein each region for a corresponding agent contains embeddings representing capabilities of the corresponding agent for processing requests; identifying, via the at least one processor, one or more regions in the multidimensional space encompassing an embedding of a request; and routing, via the at least one processor, the request to one or more agents associated with the one or more regions to process the request.

### TECHNICAL FIELD

The present disclosure relates to routing in a multi-agent framework.

### BACKGROUND

As enterprises embrace generative artificial intelligence (AI) to build virtual assistants (or agents), these assistants are specialized in their respective domains in order to offer guarantees on performance metrics, such as precision and reliability. This is accomplished through custom fine-tuned large language models (LLMs), using retrieval-augmented generation (RAG) mechanisms with the proper domain knowledge, or a combination thereof. In order to provide a cohesive customer experience, the specialized agents are interconnected over a fabric that handles request routing from a source agent that receives a user request to a target agent that has the necessary skills to service and answer that request. Each agent may offer its own native user interface, which is typically integrated into one or more of the enterprise products, and can process user queries meant for the agent itself or for remote agents interconnected over the fabric.

For example, multiple virtual assistant agents may each be configured to cover a corresponding topic (e.g., security products, collaboration, networking, etc.). The agents are interconnected in a fabric that supports request routing to the proper agent that can service a user request or query regardless of which source agent interacts with the user. By way of example, a user may be using a networking agent, and has a query regarding firewall policies that needs to be serviced by a security agent.

An approach to route user requests to an appropriate agent is based on semantic similarity in a vector space. Predefined routing policies are registered by listing example utterances (or phrases) for a given routing policy. The degree of similarity of an embedding of the user query is compared to the example utterances for the various predefined routing policies in order to determine a best matching route.

However, the approach does not support routing based on a context absent in the user utterance. For example, an intent such as “which access-point has the highest client density in my network” may need to be routed to different agents depending on the particular product used at a customer site. Since the user phrase itself does not provide this context, request routing based on semantic analysis of phrases/utterances is insufficient.

### BRIEF DESCRIPTION OF THE DRAWINGS

FIG. 1 is a block diagram of an example framework in which request routing may be implemented, according to an example embodiment.

FIG. 2 is a flowchart of a method for routing requests to corresponding agents, according to an example embodiment.

FIG. 3 is a flowchart of a method for determining agents to process requests, according to an example embodiment.

FIG. 4A illustrates an example vector space for a source agent for determining agents to process requests, according to an example embodiment.

FIG. 4B illustrates an example vector space for a unified router for determining agents to process requests, according to an example embodiment.

FIG. 5 illustrates a flowchart of a generalized method for routing requests to corresponding agents, according to an example embodiment.

FIG. 6 illustrates a hardware block diagram of a computing device configured to perform functions associated with routing requests to corresponding agents as discussed herein, according to an example embodiment.

### DETAILED DESCRIPTION

### Overview

An example embodiment provides for skill-based registration and routing across artificial intelligence (AI) agents in a fabric or framework based on semantic overlap in a vector space using polytope boundaries for skill advertisement and route look-up. In one form, a method is provided comprising defining, via at least one processor, regions for corresponding agents of a framework within a multidimensional space, wherein each region for a corresponding agent contains embeddings representing capabilities of the corresponding agent for processing requests; identifying, via the at least one processor, one or more regions in the multidimensional space encompassing an embedding of a request; and routing, via the at least one processor, the request to one or more agents associated with the one or more regions to process the request.

### Example Embodiments

An example embodiment provides a dynamic mechanism for skills registration that may be used for semantic routing of requests in a fabric or framework of interconnected AI agents. Each AI agent registers their skills or capabilities (e.g., a set of user intents and contexts that the AI agent is capable of handling, etc.). An initial agent receiving a user request routes the user request to an appropriate target agent for processing based on the skills of the target agent corresponding to a user intent (or requested functionality) in the request.

It will be appreciated that the techniques of example embodiments may be performed for routing of any types of requests or queries (e.g., for any desired information or actions) to any types of artificial intelligence (AI) or other agents capable of processing the requests. Further, the present embodiments may be applied to any structure, framework, and/or fabric of agents coupled in any fashion. The skills or capabilities of an agent may be based on any attributes pertaining to the types of requests that may be processed by the agent (e.g., products, topics, actions, set of commands, intents, contexts (e.g., network or other environment attributes, etc.), etc.). An intent of an agent may include any natural language or other description of a purpose (or functionality) of the agent. An intent of a request may include any natural language or other description of a purpose (or requested functionality) for the request, while the context may include any attributes pertaining to the request (e.g., item, topic, network or other environment attributes, etc.).

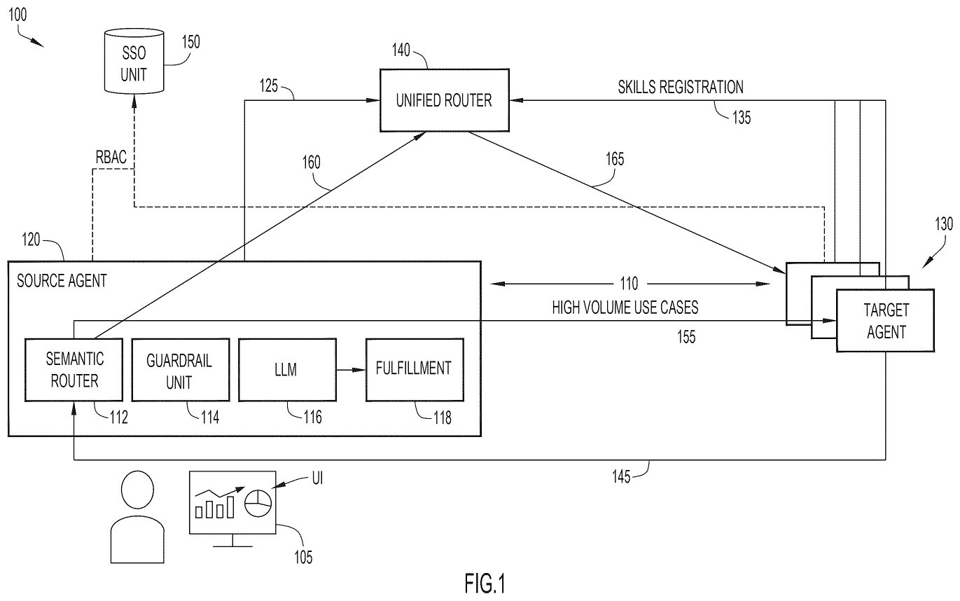

FIG. 1 illustrates an example framework 100 in which an embodiment presented herein may be implemented. Framework 100 includes a plurality of agents 110, a unified router 140, and a single sign-on (SSO) unit 150. Each agent 110 includes skills or capabilities to process certain requests or queries (e.g., certain topics, products, actions, set of commands, etc.). By way of example, framework 100 may be employed for a call or support center to provide responses to requests or queries for information for items (e.g., products, services, etc.). However, the framework may be employed for various scenarios. The request preferably includes text (or audio converted to text), while the response may include text (or audio converted from text), figures, diagrams, tables, and/or other visual elements.

The skills of agents 110 are dynamically registered with unified router 140 to enable the unified router to route requests to the appropriate agents for processing. In other words, unified router 140 determines, and routes a request to, one or more agents 110 with sufficient skills or capabilities to process the request. In addition, the skills of certain agents (e.g., handling high volume requests or use cases) may be dynamically registered with other agents 110 for direct routing of requests (without unified router 140) to those other agents. The routing information for the certain agents may be stored in a cache for rapid access and routing. The registration is dynamic and may be updated (or performed) as skills or capabilities of agents 110 change and/or new agents 110 are added to framework 100. Single sign-on unit 150 provides any conventional or other security that enables access of the framework and other platforms by a user using a single set of login or other credentials. The security may further provide any conventional or other roles based access control (RBAC, as viewed in FIG. 1) that controls system access for users based on user roles and locations.

Agents 110 may include a source agent 120 that receives a request from an end-user device 105 of a user, and one or more target agents 130 with skills or capabilities to process certain requests or queries (e.g., certain topics, products, actions, set of commands, etc.). Any agents 110 may serve as a source agent 120 and/or target agent 130 to receive and process requests. Source agent 120 provides a user interface (for end-user device 105) to receive requests and provide results for the request. The request preferably includes text (or audio converted to text), while the results preferably include text (or audio converted from text). Further, source agent 120 verifies the user (e.g., via SSO unit 150), and analyzes the request for routing decisions (e.g., routing to unified router 140 and/or appropriate agents 110 (e.g., source agent 120 and/or target agents 130) with sufficient skills or capabilities to process the request). End-user device 105, source agent 120, target agents 130, unified router 140, and SSO unit 150 may be local to each other and/or communicate over a communication network that may include one or more wide area networks (WANs), such as the Internet, and one or more local area networks (LANs). These components may communicate with each other over the communication network using a variety of known or hereafter developed communication protocols.

Source agent 120 includes a semantic router 112, a guardrail unit 114, and an LLM 116. Target agents 130 may be substantially similar to source agent 120 and include these components. Semantic router 112 analyzes a request for routing according to example embodiments as described below. Guardrail unit 114 may monitor the request and results from LLM 116 for malicious queries, queries outside the terms of service, and/or hallucinations (or incorrect or irregular results) from LLM 116 and perform remedial actions (e.g., discard an improper request or irregular results, etc.) via any conventional or other techniques.

LLM 116 processes a request and produces results or fulfillment 118 when source agent 120 has sufficient skills or capabilities to process the request. By way of example, LLM 116 may employ any conventional or other large language model (LLM) and natural language processing (NLP) techniques to process the request and provide requested information and/or perform actions. These techniques can parse and understand text, and extract various elements, data types, tasks, and other relevant information. This information can be used to produce results for the request. The LLM may receive a prompt or natural language instruction, and process the prompt to determine the actions to be performed to produce the results. The prompt may include several variations and forms.

However, any quantity of any conventional or other machine learning and/or natural language processing (NLP) models may be used (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to provide the corresponding skills or capabilities for handling certain requests associated with an agent 110 (e.g., certain topics, products, actions, set of commands, etc.).

For example, neural networks may include an input layer, one or more intermediate layers (e.g., including any hidden layers), and an output layer. Each layer includes one or more neurons, where the input layer neurons receive input (e.g., text or text features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various text (e.g., request/query, etc.) as input and corresponding desired outputs (e.g., results for requests or queries, actions to perform to retrieve results for requests or queries, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output (e.g., results for requests or queries, actions to perform to retrieve results for requests or queries, etc.). The output with the highest probability may be selected as the result.

Source agent 120 registers its skills or capabilities with unified router 140 at flow 125, while target agents 130 register their skills or capabilities with unified router 140 at flows 135. In addition, certain target agents 130 (e.g., handling high volume requests or use cases, etc.) may register their skills or capabilities with source agent 120 at flow 145. Target agents 130 may register their skills or capabilities directly with source agent 120 (e.g., for data privacy, etc.) or through unified router 140. The high volume use cases may be determined based on a quantity of cases (or specific types of requests) processed by source or target agents 120, 130 satisfying a threshold.

Source agent 120 may receive a request from end-user device 105. Semantic router 112 of source agent 120 analyzes the request to render routing decisions. For example, semantic router 112 may determine that source agent 120 has sufficient skills or capabilities to process the request. In this case, the request is processed by LLM 116 of source agent 120, and the results are returned to end-user device 105.

When semantic router 112 of source agent 120 determines that one or more target agents 130 registered with source agent 120 have sufficient skills or capabilities to process the request, semantic router 112 directly routes the request from source agent 120 to the determined target agents for processing at flow 155. The determined target agents process the request (e.g., via their corresponding LLMs 116 in substantially the same manner described above) and return results to source agent 120. The source agent combines the results from the target agents and provides an overall result to end-user device 105.

When semantic router 112 of source agent 120 determines that neither source agent 120 nor target agents 130 registered with source agent 120 have sufficient skills or capabilities to process the request, semantic router 112 of source agent 120 routes the request to unified router 140 at flow 160. Since unified router 140 preferably has registrations for all target agents 130 (or a greater quantity of target agents 130 than source agent 120), unified router 140 determines target agents 130 having sufficient skills or capabilities to process the request, and routes the request to the determined target agents at flow 165. The determined target agents process the request (e.g., via their corresponding LLMs 116 in substantially the same manner described above) and return results to unified router 140. Alternatively, the target agent may route the response directly to the source agent, if instructed to do so by the unified router. The unified router provides the results from the determined target agents to source agent 120. The source agent combines the results and provides an overall result to end-user device 105.

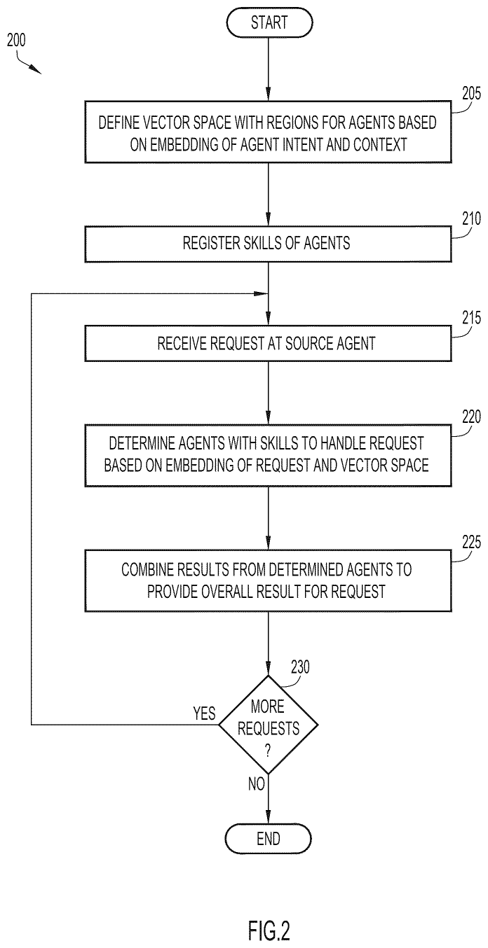

With continued reference to FIG. 1, FIG. 2 illustrates a flowchart of a method 200 for routing requests to corresponding agents, according to an example embodiment. Initially, a vector or multidimensional space is defined based on embeddings of intent and context for each of agents 110 (e.g., (intent, context)-tuples) at operation 205. The intent and context indicate skills or capabilities of an agent 110. Basically, each word or phrase (or tuple) may be represented by a vector (or embedding) having numeric elements corresponding to a plurality of dimensions (of the vector space). Words (or phrases or tuples with) similar meanings have similar word embeddings or vector representations. The word embeddings are produced from machine learning techniques or models (e.g., neural network as described above, etc.) based on an analysis of word usage in a collection of text or documents. The embeddings or vector representations may be pre-existing, and/or produced using any conventional or other tools or techniques (e.g., GLOVE, WORD2VEC, etc.).

The dimensions of the embeddings correspond to dimensions of the vector space to map the embeddings to the vector space. In other words, an embedding may serve as coordinates in the vector space to identify a location in the vector space for the embedding (e.g., intent and context, etc.). The collective (intent, context) embeddings of each agent 110 occupy a corresponding discrete region in the vector space. The region may include two or more dimensions. By way of example, the region includes a convex polytope (e.g., n-dimensional generalization of a convex polygon within that n-dimensional space). In an example embodiment, the polytopes can be n-dimensional hypercubes. In other words, each region defines the entire set of skills or capabilities (e.g., intents, contexts, etc.) for a corresponding agent 110 and, thus, represents the boundary of the agent skills or capabilities. The regions of agents 110 may overlap which enables user requests to be multicast to, and processed by, more than one agent 110 as described below.

For example, an agent 110 can have each supported intent and context (e.g., skill or capability) indicated by a vector (or embedding) of ranges defined by minimum and maximum values for each dimension (e.g., based on different terminology or expressions for the intent and context, etc.). By way of example, a vector of n dimensions may be expressed as: {[dimension 1 (minimum value, maximum value)], [dimension 2 (minimum value, maximum value)], . . . [dimension n (minimum value, maximum value]}.

The totality of requests or queries which can be answered by a specific agent 110 may be represented as a set of these vectors (which define the boundaries of the region for the agent in the multidimensional or vector space). The set of vectors enables determination of whether a request or query is within the purview of skills or capabilities of a specific agent. By way of example, a request may be encoded as a single n-dimensional request vector (or embedding) in substantially the same manner described above. The request vector may be expressed as: {[dimension1], [dimension 2], . . . , [dimension n]}. The determination may be accomplished by numerical comparisons which check whether the dimensions of the request vector are within the dimension ranges (of the set of vectors) for the intents and contexts supported by an agent.

The skills or capabilities of an agent 110 may be based on any attributes pertaining to the types of requests that may be processed by the agent (e.g., products, topics, actions, set of commands, intents, contexts (e.g., network or other environment attributes, etc.), etc.). An intent of an agent 110 may include any natural language or other description of a purpose (or functionality) of the agent. By way of example, the skills or capabilities (e.g., intent and context, etc.) for an agent 110 may include client IP address pools for each managed virtual routing and forwarding (VRF) for a network macro-segment, network device IP address pools (e.g., for NetOps device management), geographic segmentation (e.g., an area under responsibility of a network controller), various tenants supported within a network controller datastore, different services maintained for service level agreements (SLAs) (e.g., level 2 VPN (L2VPN), level 3 VPN (L3VPN), etc.), and/or namespace division (e.g., context of managed objects under a network controller). Embeddings for one or more of these intents and contexts for an agent 110 may be generated to determine the region in the vector space indicating the boundary of skills or capabilities for the agent.

Agents 110 dynamically register their skills with other agents and/or unified router 140 at operation 210. Target agents 130 may register with source agent 120 for high volume use cases. Target agents 130 may register their skills or capabilities directly with source agent 120 (e.g., for data privacy, etc.) or through unified router 140. The high volume use cases may be determined based on a quantity of cases (or specific types of requests) processed by source or target agents 120, 130 satisfying a threshold. The high volume use cases may be supported differently based on an identity of the source agent receiving the registration. This effectively enables custom behavior from a target agent 130 on answers to specific types of requests or queries based on the source agent 120 providing the query. Registration may be accomplished by an agent 110 providing bounds of the corresponding region in the vector space (defining the agent skills or capabilities) to another agent and/or unified router 140. The bounds may be represented by the set of vectors described above or by any quantity of any types of coordinate values in the vector space to indicate the boundaries of the region. Agents 110 and/or unified router 140 receiving the registration update their registration and routing information accordingly.

A user request from an end-user device 105 is received at a source agent 120 at operation 215. Semantic router 112 of source agent 120 analyzes the request to render routing decisions for determining agents (e.g., source agent 120 and target agents 130) with sufficient skills or capabilities to process the request at operation 220. For example, semantic router 112 of source agent 120 determines an embedding of the request (e.g., embedding of intent (or desired functionality) and context within the request), and identifies potential regions within a vector space for the source agent and/or target agents 130 registered with the source agent that encompass the embedding of the request. The intent and context of the request may be determined using any conventional or other natural language processing (NLP) techniques. When the region of source agent 120 is identified, the source agent may process the request (e.g., via LLM 116) to produce results. In other words, if the coordinates of the vector representing the embedding of the user request fall or reside within the region of the source agent, then the source agent may process the request. When one or more regions of target agents 130 registered with source agent 120 are identified, source agent 120 directly routes or sends the request to the target agents associated with the one or more identified regions to process the request (e.g., via corresponding LLMs 116 of the target agents). In other words, if the coordinates of the vector representing the embedding of the user request fall or reside within the regions of one or more target agents, then the one or more target agents may process the request. The results of the request from target agents 130 are returned to source agent 120.

In the event that the embedding of the request resides outside the regions of source agent 120 and the target agents 130 registered with the source agent (e.g., source agent 120 is unable to identify a region or agent), the request is routed or sent by source agent 120 to unified router 140. Since unified router 140 preferably has registrations for all target agents 130 (or a quantity of target agents 130 greater than source agent 120), unified router 140 identifies the one or more regions in the vector space for the target agents encompassing the embedding of the request. When no regions can be identified (e.g., no regions encompass the embedding of the request), a closest or nearest region may be identified. Unified router 140 routes or sends the request to the target agents 130 associated with the one or more identified regions to process the request (e.g., via corresponding LLMs 116 of the target agents). The results of the request are returned from target agents 130 to unified router 140 and provided to source agent 120. This technique allows a cut-through mode from source agent 120 directly to target agents 130 for high volume requests, while maintaining unified router 140 as a default gateway for routing requests to target agents 130 whose skills are not known to source agent 120.

The results from the identified agents (or unified router 140) are combined by source agent 120 to produce an overall result at operation 225 that is provided to end-user device 105 in response to the request. The above process is repeated from operation 215 for additional requests until the requests have been processed as determined at operation 230.

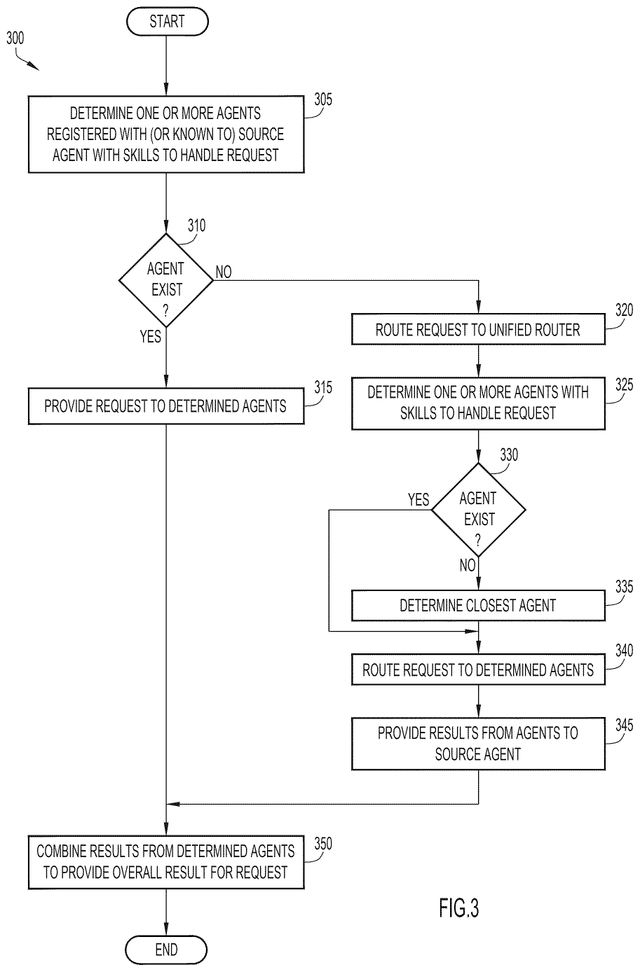

With continued reference to FIGS. 1 and 2, FIG. 3 illustrates a flowchart of a method 300 for determining agents to process requests, according to an example embodiment. This may correspond to operations 220 and 225 of FIG. 2. Initially, a vector or multidimensional space is defined based on embeddings of intent and context for each of agents 110 (e.g., (intent, context)-tuples) in substantially the same manner described above. The collective (intent, context) embeddings of each agent 110 occupy a corresponding discrete region in the vector space. In other words, each region defines the entire set of skills or capabilities (e.g., intents, contexts, etc.) for a corresponding agent 110 and, thus, represents the boundary of the agent skills or capabilities in substantially the same manner described above. Agents 110 dynamically register their skills with other agents and/or unified router 140 in substantially the same manner described above (e.g., an agent 110 providing bounds of the corresponding region in the vector space to another agent and/or unified router 140).

A user request from an end-user device 105 is received at a source agent 120, and semantic router 112 of source agent 120 analyzes the request to determine one or more agents (e.g., source agent 120 and target agents 130), registered with or known to the source agent, with sufficient skills or capabilities to process the request at operation 305. For example, semantic router 112 of source agent 120 determines an embedding of the request (intent and context) mapped to the vector space, and identifies potential regions within the vector space for the source agent and/or target agents 130 registered with the source agent that encompass or contain the embedding of the request. This may be accomplished by comparing the request embedding (corresponding to coordinates in the vector space) to boundaries of the regions (corresponding to source and target agents) provided during registration and/or known to the source agent in substantially the same manner described above.

In addition, there may be scenarios where the request embedding is contained within more than one region due to overlapping. In this case, a selection technique may be employed to identify an appropriate region and corresponding agent 120 and/or 130. For example, each of agents 120, 130 associated with the regions containing the request embedding may be selected (e.g., the request may be routed or sent (multicast) to each of those agents). Further, the region having the closest or most explicit match may be selected. This may be determined based on any conventional or other distances of the request embedding to portions of the region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

When at least one agent exists (e.g., at least one region is identified, etc.) as determined at operation 310, semantic router 112 of source agent 120 provides the request to the agents corresponding to the identified regions at operation 315. For example, when the region of source agent 120 is identified, the source agent may process the request (e.g., via LLM 116 of source agent 120) to produce results. In the event, one or more regions of target agents 130 registered with source agent 120 are identified, semantic router 112 of source agent 120 directly routes or sends the request to the target agents associated with the one or more identified regions to process the request (e.g., via corresponding LLMs 116 of the target agents). The results of the request from the target agents 130 are returned to source agent 120.

Source agent 120 combines the results from the identified agents at operation 350 to produce an overall result for the request that is provided to end-user device 105. For example, the results of the agents may be aggregated, collated, joined, merged, or otherwise combined or formatted to produce the overall result. By way of example, a request may be provided to agents 110 with different specialties that may produce varying information for the request. Source agent 120 extracts the appropriate information (e.g., may ignore duplicate or cumulative information, identify relevant information for the request, etc.) from the agent results via any conventional or other techniques to produce the overall result.

When no agent exists (e.g., no region is identified that contains the embedding of the request, etc.) as determined at operation 310, semantic router 112 of source agent 120 routes or sends the request to unified router 140 at operation 320. Since unified router 140 preferably has registrations for all target agents 130 (or for a greater quantity of target agents than source agent 120), unified router 140 identifies one or more target agents 130 with sufficient skills or capabilities to process the request at operation 325. For example, unified router 140 determines an embedding of the request (intent and context) mapped to the vector space. The intent and context of the request may be determined using any conventional or other natural language processing (NLP) techniques. Alternatively, unified router 140 may receive the embedding from source agent 120. Unified router 140 identifies potential regions within the vector space for target agents 130 that encompass or contain the embedding of the request. This may be accomplished by comparing the request embedding (corresponding to coordinates in the vector space) to boundaries of the regions corresponding to target agents 130 provided during registration in substantially the same manner described above.

In addition, there may be scenarios where the request embedding is contained within more than one region due to overlapping. In this case, a selection technique may be employed to identify an appropriate region and corresponding target agent 130. For example, each of the target agents associated with the regions containing the request embedding may be selected (e.g., the request may be routed or sent (multicast) to each of those target agents). Further, the region having the closest or most explicit match may be selected. This may be determined based on any conventional or other distances of the request embedding to portions of a region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

When no agent exists (e.g., no region is identified, etc.) as determined at operation 330, unified router 140 identifies a closest or nearest region to the embedding of the request at operation 335. This may be determined based on a shortest distance in the vector space between the request embedding and one or more boundaries of the regions using any conventional or other techniques (e.g., Euclidean or other distance metrics, cosine similarity, etc.).

Once the regions are identified, unified router 140 routes or sends the request to target agents 130 corresponding to the identified regions at operation 340 to process the request (e.g., via corresponding LLMs 116 of the target agents). The results of the request from the target agents are returned to unified router 140 and provided to source agent 120 at operation 345. Source agent 120 combines the results from the identified agents at operation 350 to produce an overall result for the request that is provided to end-user device 105 in substantially the same manner described above.

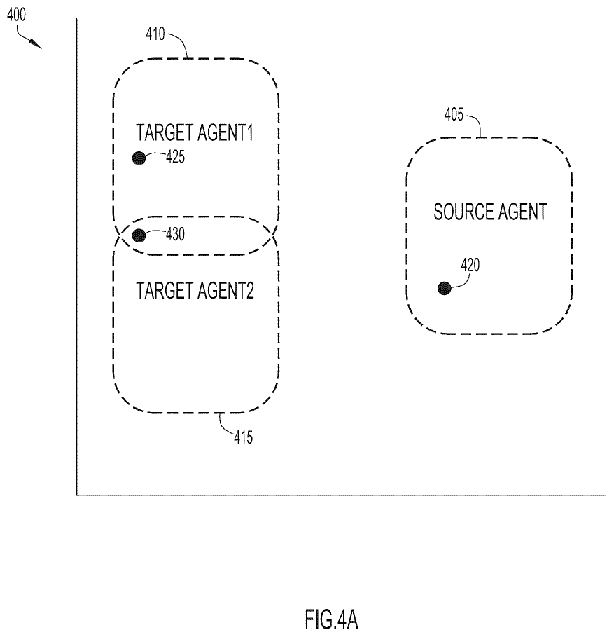

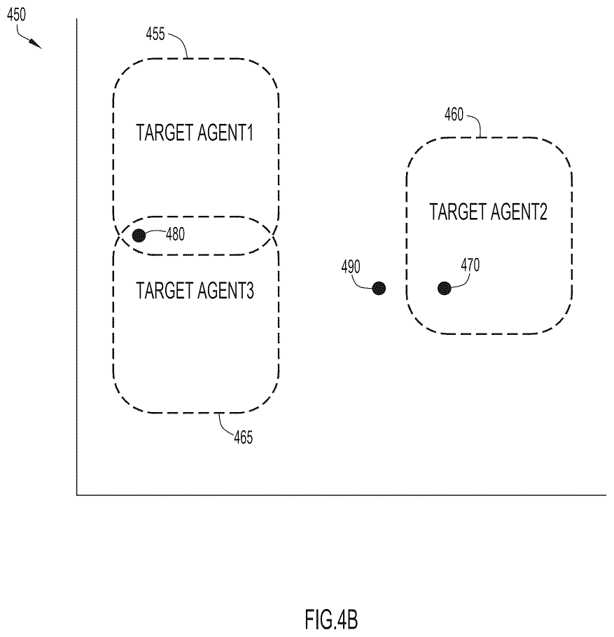

With continued reference to FIGS. 1-3 , FIG. 4A illustrates an example vector space 400 for a source agent 120 for determining agents to process requests, according to an example embodiment. Initially, vector space 400 includes dimensions corresponding to the dimensions of embeddings of requests and agent intents and contexts. The collective (intent, context) embeddings of source agent 120 (e.g., SOURCE AGENT as viewed in FIG. 4A) and each target agent 130 (e.g., TARGET AGENT1 and TARGET AGENT2 as viewed in FIG. 4A) occupy a corresponding discrete region in the vector space. By way of example, vector space 400 includes a region 405 corresponding to source agent 120, a region 410 corresponding to TARGET AGENT1 registered with source agent 120, and a region 415 corresponding to TARGET AGENT2 registered with source agent 120. Accordingly, each region 405, 410, 415 defines the entire set of skills or capabilities (e.g., intents, contexts, etc.) for the corresponding agent and, thus, represents the boundary of the agent skills or capabilities. However, the vector space may include any quantity of regions for any quantity of agents 110.

Source agent 120 may receive a request and determine an embedding 420 of the request (intent and context) mapped to vector space 400 in substantially the same manner described above. Semantic router 112 of source agent 120 identifies region 405 that encompasses or contains embedding 420 of the request (based on a comparison of the request embedding to boundaries of regions 410, 415 of vector space 400 provided during registration and to boundaries of region 405 known to the source agent) in substantially the same manner described above. Since region 405 corresponds to source agent 120, the source agent may process the request to produce results in substantially the same manner described above.

Source agent 120 may receive another request and determine an embedding 425 of the request (intent and context) mapped to vector space 400 in substantially the same manner described above. Semantic router 112 of the source agent identifies region 410 that encompasses or contains embedding 425 of the request (based on a comparison of the request embedding to boundaries of regions 410, 415 of vector space 400 provided during registration and to boundaries of region 405 known to the source agent). Since region 410 corresponds to TARGET AGENT1, semantic router 112 of source agent 120 directly routes or sends the request to TARGET AGENT1 to process the request (e.g., via corresponding LLM 116) in substantially the same manner described above. The results of the request from TARGET AGENT1 are returned to source agent 120 to provide results for the request in substantially the same manner described above.

Source agent 120 may receive yet another request and determine an embedding 430 of the request (intent and context) mapped to vector space 400 in substantially the same manner described above. Semantic router 112 of source agent 120 identifies regions 410 and 415 that each encompass or contain embedding 430 of the request (based on a comparison of the request embedding to boundaries of regions 410, 415 of vector space 400 provided during registration and to boundaries of region 405 known to the source agent) in substantially the same manner described above. Since regions 410, 415 correspond to TARGET AGENT1 and TARGET AGENT2, semantic router 112 of source agent 120 directly routes or sends the request to TARGET AGENT1 and TARGET AGENT2 to process the request (e.g., via corresponding LLMs 116) in substantially the same manner described above. The results of the request from TARGET AGENT1 and TARGET AGENT2 are returned to source agent 120 to provide results for the request in substantially the same manner described above.

In the event that the embedding of a request resides outside the regions of vector space 400 (e.g., corresponding to source agent 120 and target agents 130 registered with the source agent), the request is routed or sent by semantic router 112 of source agent 120 to unified router 140. Since unified router 140 preferably has registrations for all target agents 130 (or for a greater quantity of target agents than source agent 120), unified router 140 identifies one or more target agents 130 to process the request. With continued reference to FIGS. 1-3 and 4A , FIG. 4B illustrates an example vector space 450 for unified router 140 for determining agents to process requests, according to an example embodiment. Initially, vector space 450 includes dimensions corresponding to the dimensions of embeddings of requests and agent intents and contexts. The collective (intent, context) embeddings of each target agent 130 (e.g., TARGET AGENT1, TARGET AGENT2, and TARGET AGENT3 as viewed in FIG. 4B) occupy a corresponding discrete region in the vector space. By way of example, vector space 450 includes a region 455 corresponding to TARGET AGENT1, a region 460 corresponding to TARGET AGENT2, and a region 465 corresponding to TARGET AGENT3. Accordingly, each region 455, 460, 465 defines the entire set of skills or capabilities (e.g., intents, contexts, etc.) for the corresponding agent and, thus, represents the boundary of the agent skills or capabilities. However, the vector space may include any quantity of regions for any quantity of agents 110.

Unified router 140 may receive a request from source agent 120 and determine an embedding 470 of the request (intent and context) mapped to vector space 450 in substantially the same manner described above. Alternatively, the unified router may receive embedding 470 from source agent 120 in substantially the same manner described above. Unified router 140 identifies region 460 that encompasses or contains embedding 470 of the request (based on a comparison of the request embedding to boundaries of the regions of vector space 450 provided during registration) in substantially the same manner described above. Since region 460 corresponds to TARGET AGENT2, unified router 140 routes or sends the request to TARGET AGENT2 to process the request (e.g., via corresponding LLM 116) in substantially the same manner described above. The results of the request from TARGET AGENT2 are returned to unified router 140 and provided to source agent 120 to produce results for the request in substantially the same manner described above.

Unified router 140 may receive another request from source agent 120 and determine an embedding 480 of the request (intent and context) mapped to vector space 450 in substantially the same manner described above. Alternatively, unified router 140 may receive embedding 480 from source agent 120 in substantially the same manner described above. The unified router identifies regions 455 and 465 that each encompass or contain embedding 480 of the request (based on a comparison of the request embedding to boundaries of the regions of vector space 450 provided during registration) in substantially the same manner described above. Since regions 455, 465 correspond to TARGET AGENT1 and TARGET AGENT3, unified router 140 routes or sends the request to TARGET AGENT1 and TARGET AGENT3 to process the request (e.g., via corresponding LLMs 116) in substantially the same manner described above. The results of the request from TARGET AGENT1 and TARGET AGENT3 are returned to unified router 140 and provided to source agent 120 to produce results for the request in substantially the same manner described above.

Unified router 140 may receive yet another request from source agent 120 and determine an embedding 490 of the request (intent and context) mapped to vector space 450 in substantially the same manner described above. Alternatively, unified router 140 may receive embedding 490 from source agent 120 in substantially the same manner described above. Since embedding 490 resides outside regions 455, 460, 465 of vector space 450, unified router 140 is unable to initially identify a target agent to process the request (based on a comparison of the request embedding to boundaries of the regions of vector space 450 provided during registration). In this case, unified router 140 identifies a closest or nearest region to embedding 490. This may be determined based on a shortest distance in vector space 450 between embedding 490 and one or more boundaries of regions 455, 460, 465 using any conventional or other techniques (e.g., Euclidean or other distance metrics, cosine similarity, etc.) in substantially the same manner described above.

By way of example, embedding 490 may be closest to region 460 (e.g., as viewed in FIG. 4B). Since region 460 corresponds to TARGET AGENT2, unified router 140 routes or sends the request to TARGET AGENT2 to process the request (e.g., via corresponding LLM 116) in substantially the same manner described above. The results of the request from TARGET AGENT2 are returned to unified router 140 and provided to source agent 120 to produce results for the request in substantially the same manner described above.

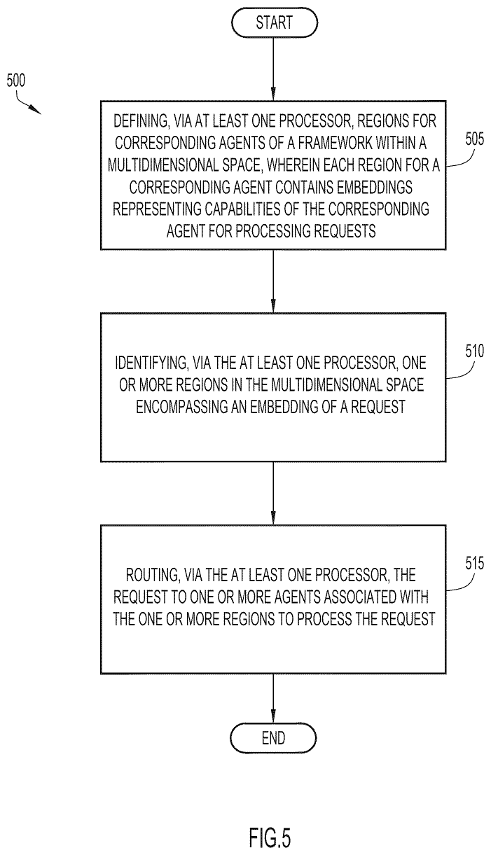

FIG. 5 is a flowchart of an example method 500 for routing requests to corresponding agents, according to an example embodiment. At operation 505, regions for corresponding agents of a framework are defined within a multidimensional space via at least one processor. Each region for a corresponding agent contains embeddings representing capabilities of the corresponding agent for processing requests. At operation 510, one or more regions in the multidimensional space encompassing an embedding of a request are identified via the at least one processor. At operation 515, the request is routed, via the at least one processor, to one or more agents associated with the one or more regions to process the request.

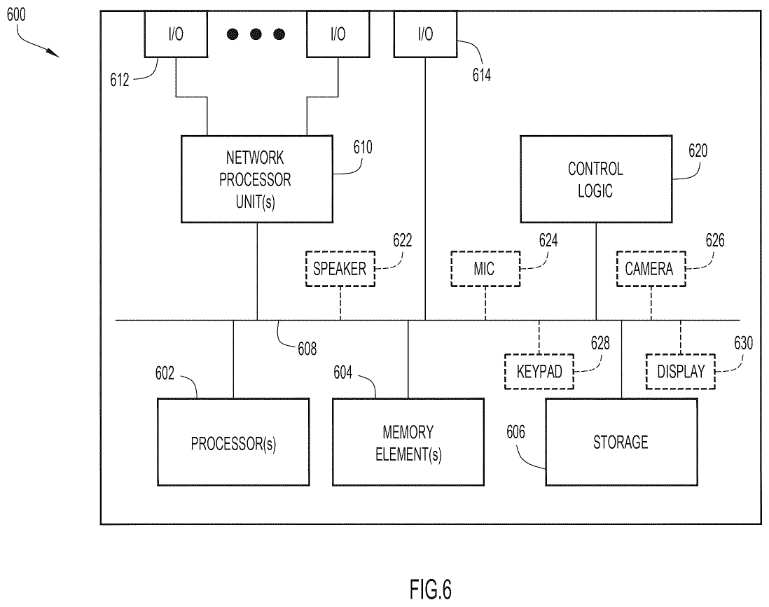

Referring to FIG. 6, FIG. 6 illustrates a hardware block diagram of a computing device 600 that may perform functions associated with operations discussed herein in connection with the techniques depicted in FIGS. 1-3, 4A, 4B , and 5. In various embodiments, a computing device or apparatus or system, such as computing device 600 or any combination of computing devices 600, may be configured as any device entity/entities (e.g., network nodes, computer devices, end-user devices, servers, client devices, communication devices, network devices, processors, switching devices, network interfaces, agents, routers, etc.) as discussed for the techniques depicted in connection with FIGS. 1-3, 4A, 4B , and 5 in order to perform operations of the various techniques discussed herein.

In at least one embodiment, computing device 600 may be any apparatus that may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory elements 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interfaces 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, end-user device, network device, network nodes, processors, network interfaces, switching devices, agents, routers, etc.), computing device 600 may further include, or be coupled to, a speaker 622 to convey sound, microphone or other sound sensing device 624, camera or image capture device 626, a keypad or keyboard 628 to enter information (e.g., alphanumeric information, etc.), and/or a touch screen or other display 630. These items may be coupled to bus 608 or I/O interface(s) 614 to transfer data with other elements of computing device 600.

In various embodiments, control logic 620 can include instructions that, when executed, cause processor(s) 602 to perform operations, which can include, but not be limited to, providing overall control operations of computing device 600; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory elements 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4(IPv4) and/or IP version 6(IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: defining, via at least one processor, regions for corresponding agents of a framework within a multidimensional space, wherein each region for a corresponding agent contains embeddings representing capabilities of the corresponding agent for processing requests; identifying, via the at least one processor, one or more regions in the multidimensional space encompassing an embedding of a request; and routing, via the at least one processor, the request to one or more agents associated with the one or more regions to process the request.

In one example, the corresponding agents include artificial intelligence agents and a region for the corresponding agent is defined by a set of embeddings of intents and contexts for the corresponding agent, the set of embeddings includes ranges for each dimension, and the one or more regions are identified based on dimensions of the embedding of the request being within the ranges of the set of embeddings for the one or more regions.

In one example, identifying the one or more regions comprises identifying a plurality of regions in the multidimensional space encompassing the embedding of the request, and routing the request to one or more agents comprises routing the request to each of a plurality of agents associated with the plurality of regions.

In one example, the method further comprises identifying, via the at least one processor, a region associated with a corresponding agent nearest to the embedding of the request in the multidimensional space when the embedding of the request corresponds to a location in the multidimensional space outside the regions of the corresponding agents.

In one example, defining the regions for corresponding agents comprises defining the regions for corresponding agents handling high volume requests, and routing the request to one or more agents comprises directly routing the request to the one or more agents.

In one example, the method further comprises receiving the request, via the at least one processor, from a source agent of the framework when the source agent is unable to identify at least one agent to process the request.

In one example, defining the regions for the corresponding agents comprises removing overlapping segments from the regions for the corresponding agents.

In another form, an apparatus is provided. The apparatus comprises a router to enable communications; memory; and at least one processor configured to perform operations including: defining regions for corresponding agents of a framework within a multidimensional space, wherein each region for a corresponding agent contains embeddings representing capabilities of the corresponding agent for processing requests; identifying one or more regions in the multidimensional space encompassing an embedding of a request; and routing the request to one or more agents associated with the one or more regions to process the request.

In another form, one or more non-transitory computer readable storage media are provided. The one or more non-transitory computer readable storage media are encoded with processing instructions that, when executed by one or more processors, cause the one or more processors to perform operations including: defining regions for corresponding agents of a framework within a multidimensional space, wherein each region for a corresponding agent contains embeddings representing capabilities of the corresponding agent for processing requests; identifying one or more regions in the multidimensional space encompassing an embedding of a request; and routing the request to one or more agents associated with the one or more regions to process the request.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
defining, via at least one processor, regions for corresponding agents of a framework within a multidimensional space, wherein each region for a corresponding agent contains embeddings representing capabilities of the corresponding agent for processing requests;
identifying, via the at least one processor, one or more regions in the multidimensional space encompassing an embedding of a request; and
routing, via the at least one processor, the request to one or more agents associated with the one or more regions to process the request.

2. The method of claim 1, wherein the corresponding agents include artificial intelligence agents and a region for the corresponding agent is defined by a set of embeddings of intents and contexts for the corresponding agent, wherein the set of embeddings includes ranges for each dimension, and wherein the one or more regions are identified based on dimensions of the embedding of the request being within the ranges of the set of embeddings for the one or more regions.

3. The method of claim 1, wherein identifying the one or more regions comprises identifying a plurality of regions in the multidimensional space encompassing the embedding of the request, wherein routing the request to one or more agents comprises routing the request to each of a plurality of agents associated with the plurality of regions.

4. The method of claim 1, further comprising:
identifying, via the at least one processor, a region associated with a corresponding agent nearest to the embedding of the request in the multidimensional space when the embedding of the request corresponds to a location in the multidimensional space outside the regions of the corresponding agents.

5. The method of claim 1, wherein defining the regions for corresponding agents comprises defining the regions for the corresponding agents handling high volume requests, and wherein routing the request to one or more agents comprises directly routing the request to the one or more agents.

6. The method of claim 1, further comprising:
receiving the request, via the at least one processor, from a source agent of the framework when the source agent is unable to identify at least one agent to process the request.

7. The method of claim 1, wherein defining the regions for the corresponding agents comprises:
removing overlapping segments from the regions for the corresponding agents.

8. An apparatus comprising:
a router to enable communications;
memory; and
at least one processor configured to perform operations including:
defining regions for corresponding agents of a framework within a multidimensional space, wherein each region for a corresponding agent contains embeddings representing capabilities of the corresponding agent for processing requests;
identifying one or more regions in the multidimensional space encompassing an embedding of a request; and
routing the request to one or more agents associated with the one or more regions to process the request.

9. The apparatus of claim 8, wherein the corresponding agents include artificial intelligence agents and a region for the corresponding agent is defined by a set of embeddings of intents and contexts for the corresponding agent, wherein the set of embeddings includes ranges for each dimension, and wherein the one or more regions are identified based on dimensions of the embedding of the request being within the ranges of the set of embeddings for the one or more regions.

10. The apparatus of claim 8, wherein identifying the one or more regions comprises identifying a plurality of regions in the multidimensional space encompassing the embedding of the request, wherein routing the request to one or more agents comprises routing the request to each of a plurality of agents associated with the plurality of regions.

11. The apparatus of claim 8, wherein the at least one processor is further configured to perform operations including:
identifying a region associated with a corresponding agent nearest to the embedding of the request in the multidimensional space when the embedding of the request corresponds to a location in the multidimensional space outside the regions of the corresponding agents.

12. The apparatus of claim 8, wherein defining the regions for corresponding agents comprises defining the regions for the corresponding agents handling high volume requests, and wherein routing the request to one or more agents comprises directly routing the request to the one or more agents.

13. The apparatus of claim 8, wherein the at least one processor is further configured to perform operations including:
receiving the request from a source agent of the framework when the source agent is unable to identify at least one agent to process the request.

14. One or more non-transitory computer readable storage media encoded with processing instructions that, when executed by one or more processors, cause the one or more processors to perform operations including:
defining regions for corresponding agents of a framework within a multidimensional space, wherein each region for a corresponding agent contains embeddings representing capabilities of the corresponding agent for processing requests;
identifying one or more regions in the multidimensional space encompassing an embedding of a request; and
routing the request to one or more agents associated with the one or more regions to process the request.

15. The one or more non-transitory computer readable storage media of claim 14, wherein the corresponding agents include artificial intelligence agents and a region for the corresponding agent is defined by a set of embeddings of intents and contexts for the corresponding agent, wherein the set of embeddings includes ranges for each dimension, and wherein the one or more regions are identified based on dimensions of the embedding of the request being within the ranges of the set of embeddings for the one or more regions.

16. The one or more non-transitory computer readable storage media of claim 14, wherein identifying the one or more regions comprises identifying a plurality of regions in the multidimensional space encompassing the embedding of the request, and wherein routing the request to one or more agents comprises routing the request to each of a plurality of agents associated with the plurality of regions.

17. The one or more non-transitory computer readable storage media of claim 14, wherein the processing instructions further cause the one or more processors to perform operations including:
identifying a region associated with a corresponding agent nearest to the embedding of the request in the multidimensional space when the embedding of the request corresponds to a location in the multidimensional space outside the regions of the corresponding agents.

18. The one or more non-transitory computer readable storage media of claim 14, wherein defining the regions for corresponding agents comprises defining the regions for the corresponding agents handling high volume requests, and wherein routing the request to one or more agents comprises directly routing the request to the one or more agents.

19. The one or more non-transitory computer readable storage media of claim 14, wherein the processing instructions further cause the one or more processors to perform operations including:
receiving the request from a source agent of the framework when the source agent is unable to identify at least one agent to process the request.

20. The one or more non-transitory computer readable storage media of claim 14, wherein defining the regions for corresponding agents comprises:
removing overlapping segments from the regions for the corresponding agents.
